(19) United States
(12) Patent Application Publication
(10) Pub. No.: US 2015/0163726 A1
(43) Pub. Date: Jun. 11, 2015

(54) APPARATUS AND METHODS FOR SERVICE RECOVERY DURING MANUAL PLMN SEARCH

(71) Applicant: QUALCOMM Incorporated, San Diego, CA (US)

(72) Inventors: Pankaj Bansal, Jaipur (IN); Srinivasarao Pasumarthi, Hyderabad (IN); Manjunatha Subbamma Ananda, Chickballapur (IN); Nitin Sachdeva, Hyderabad (IN)

(73) Assignee: QUALCOMM Incorporated, San Diego, CA (US)

(21) Appl. No.: 14/259,881

(22) Filed: Apr. 23, 2014

Related U.S. Application Data
(60) Provisional application No. 61/913,698, filed on Dec. 9, 2013.

(51) Int. Cl. H04W 48/16

(52) U.S. Cl. CPC H04W 48/16

(57) ABSTRACT

Aspects of apparatus and methods for wireless communication include starting to perform a manual public land mobile network (PLMN) search by a user equipment (UE); while the manual PLMN search is ongoing, scanning one or more frequency bands to determine an available cell; and determining whether to camp on the available cell before the manual PLMN search is completed by the UE. In some aspects, the determining of whether to camp on the available cell includes decoding a system information block (SIB) or system information (SI) related to a cell suitability criterion of the available cell; determining whether the available cell is suitable based on the SIB or the SI; when the available cell is suitable, suspending the manual PLMN search and decoding other related SIBs or SIs of the available cell; and when the available cell is not suitable, resuming the manual PLMN search.

### CLAIM OF PRIORITY UNDER 35 U.S.C. §119

The present application for patent claims priority to U.S. Provisional Application No. 61/913,698 entitled “A METHOD TO RECOVER FROM OOS/LIMITED SERVICE DURING MANUAL PLMN SEARCH” filed Dec. 9, 2013, and assigned to the assignee hereof and hereby expressly incorporated by reference herein.

### BACKGROUND

The present disclosure relates generally to wireless communications, and more particularly, to apparatus and methods for service recovery during manual public land mobile network (PLMN) search.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Conventionally, a manual (e.g., user-initiated) public land mobile network (PLMN) search at a user equipment (UE) may take a relatively long time to complete (e.g., ranging from 30 seconds to 3 minutes). The duration of the manual PLMN search may depend on the number of frequency bands or radio access technologies (RATs) supported by the UE, and the more frequency bands/RATs supported, the longer it may take to complete the manual PLMN search. While the manual PLMN search is in progress, the UE may not be able to receive any incoming notifications or support any mobile originated (also referred to as MO) activities, even if a suitable cell belonging to, for example, a registered PLMN (RPLMN), home PLMN (HPLMN), or preferred PLMN is available. Further, this problem may be exacerbated for UEs that support a multi-subscriber identity module (multi-SIM) scheme, since another subscriber may take over the radio frequency (RF) chain, making the time to complete the manual PLMN search even longer.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the disclosure provides a method of wireless communication that includes starting to perform a manual public land mobile network (PLMN) search by a user equipment (UE); while the manual PLMN search is ongoing, scanning by the UE one or more frequency bands to determine an available cell; and determining whether to camp on the available cell before the manual PLMN search is completed by the UE.

In another aspect, the disclosure provides an apparatus for wireless communication, including a processing system configured to start to perform a manual PLMN search by a UE; while the manual PLMN search is ongoing, scan by the UE one or more frequency bands to determine an available cell; and determine whether to camp on the available cell before the manual PLMN search is completed by the UE.

In a further aspect, the disclosure provides an apparatus for wireless communications, including means for starting to perform a manual PLMN search by a UE; means for, while the manual PLMN search is ongoing, scanning by the UE one or more frequency bands to determine an available cell; and means for determining whether to camp on the available cell before the manual PLMN search is completed by the UE.

In yet another aspect, the disclosure provides a computer program product for wireless communications, including a non-transitory computer-readable medium including code for starting to perform a manual PLMN search by a UE; while the manual PLMN search is ongoing, scanning by the UE one or more frequency bands to determine an available cell; and determining whether to camp on the available cell before the manual PLMN search is completed by the UE.

These and other aspects of the present disclosure will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of a system for recovering service during manual PLMN search;

FIGS. 2 and 3 are flow charts of methods of wireless communication, including aspects of the system of FIG. 1;

FIG. 4 is a block diagram conceptually illustrating an example of a hardware implementation for an apparatus employing a processing system, including aspects of the system of FIG. 1;

FIG. 5 is a block diagram conceptually illustrating an example of a telecommunications system, including aspects of the system of FIG. 1;

FIG. 6 is a conceptual diagram illustrating an example of an access network, including aspects of the system of FIG. 1; and

FIG. 7 is a block diagram conceptually illustrating an example of a Node B in communication with a UE in a telecommunications system, including aspects of the system of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some aspects of the present disclosure provide methods and apparatus for recovering service at a user equipment (UE) when a manual public land mobile network (PLMN) search is ongoing. In some present aspects, after a manual PLMN search has started due to, for example, an out-of-service (OOS) or a limited service condition, and while the manual PLMN search is ongoing, the UE may consider any suitable cell for camping. Hence, the UE may come back in service quickly if there is a suitable cell available during the manual PLMN search, and may then perform activities such as calls or short message services (SMSs). Accordingly, the present aspects may improve user experience, as a user may prefer to avoid staying OOS or missing mobile terminated calls or SMSs.

Conventionally, when a manual PLMN search is ongoing at a UE, the UE is not able to recover from OOS or limited service until the manual PLMN search is completed. A manual PLMN search may take a relatively long time to complete (e.g., ranging from 30 seconds to 3 minutes). The duration of the manual PLMN search may depend, for example, on the number of frequency bands or radio access technologies (RATs) that are supported by the UE. For example, in WCDMA/GSM auto mode, the UE may support a relatively large number of frequency bands and RATs corresponding to WCDMA and GSM. The more frequency bands and/or RATs supported by the UE, the longer it may take for the UE to complete the manual PLMN search. While the manual PLMN search is in progress, the UE is not able to receive any incoming notifications or support any mobile originated (also referred to as MO) activities, even if a suitable cell belonging to a registered PLMN (RPLMN), a home PLMN (HPLMN), or a preferred PLMN is available during the manual PLMN search. Therefore, the UE may remain OOS and miss mobile originated or mobile terminated (also referred to as MT) calls or SMSs. This problem is even more significant in a UE that supports a multi-subscriber identity module (multi-SIM) scheme since another subscriber may take over the radio frequency (RF) chain, making the time to complete the manual PLMN search even longer.

In some present aspects, however, even after a manual PLMN search has started, the UE may consider any suitable cell for camping that belongs to an RPLMN, a HPLMN, or a preferred PLMN. Further, upon determining a suitable cell and before continuing the manual PLMN search on the remaining frequency bands or RATs, the UE may perform a location registration at the suitable cell if there is any change in a location area identifier (LAI), a routing area identifier (RAI), or a tracking area identifier (TAI). For example, a location area may identify a geographical area covered by a set of base stations, a routing area may be a subdivision of a location area, and a tracking area may correspond to a set of cells. Conventionally, a UE may receive and decode LAI, RAI, and TAI in broadcast signals from a cell to determine if there is a change in an LAI, RAI, or TAI. If there is a change in an LAI, RAI, or TAI, the UE performs a location registration at the cell. In some aspects, for example, the change in the LAI, RAI, or TAI may be due to a location change of the UE.

For example, in an aspect, the UE may include an RRC entity which may be a function, feature, component, program, or the like that is associated with an RRC protocol. In these aspects, when a manual PLMN search is ongoing, if the RRC entity of the UE (e.g., a long term evolution (LTE) radio resource control (RRC) entity, WCDMA-RRC entity, or GSM-RRC entity) determines that there is a good signal/energy available on an RPLMN, a HPLMN, or a preferred PLMN, then the UE decodes a corresponding system information block (SIB) or system information (SI) (e.g., an information element (IE)) related to cell suitability. In some aspects, for example, cell suitability criteria may include a minimum received power level and/or a minimum received signal quality level. If a cell is found to be suitable (e.g., if the UE can receive signals from the cell with at least a minimum received power level and at least a minimum received signal quality level), the UE suspends the manual PLMN search (e.g., halts the execution of the manual PLMN search) and decodes other related SIBs/SIs. In some aspects, the decoding of the other related SIBs/SIs may be necessary, required, or mandatory for performing camping/registration. If there is a LAI, RAI, or TAI change, the UE performs registration and starts decoding pages (e.g., decodes mobile terminated activities, e.g., activities terminated at the UE such as calls or SMSs received by the UE) or performs any user activities such as mobile originated activities, e.g., activities originated at the UE such as calls placed by the UE or SMSs sent by the UE.

Conventionally, during a manual PLMN search, WCDMA-RRC reads the master information block (MIB) of each cell. In some present aspects, however, if a cell belongs to an RPLMN, a HPLMN, or a preferred PLMN, WCDMA-RRC reads an extra SIB (which may be SIB3) to determine whether or not the UE is barred from the cell or the cell is reserved for the UE (e.g., determine cell suitability criterion). Once the process for camping/registration is completed, the UE may resume the manual PLMN search (e.g., proceed with the execution of the manual PLMN search that was previously halted/stopped), and search results may be displayed on a user interface.

Accordingly, in some present aspects, the UE may come back in service quickly (e.g., from acquisition database scan) if there is a suitable cell available during a manual PLMN search and the user may perform activities such as calls, SMSs, etc. As such, the present aspects improve user experience as a user may generally prefer to avoid staying OOS or missing mobile terminated calls and/or SMSs.

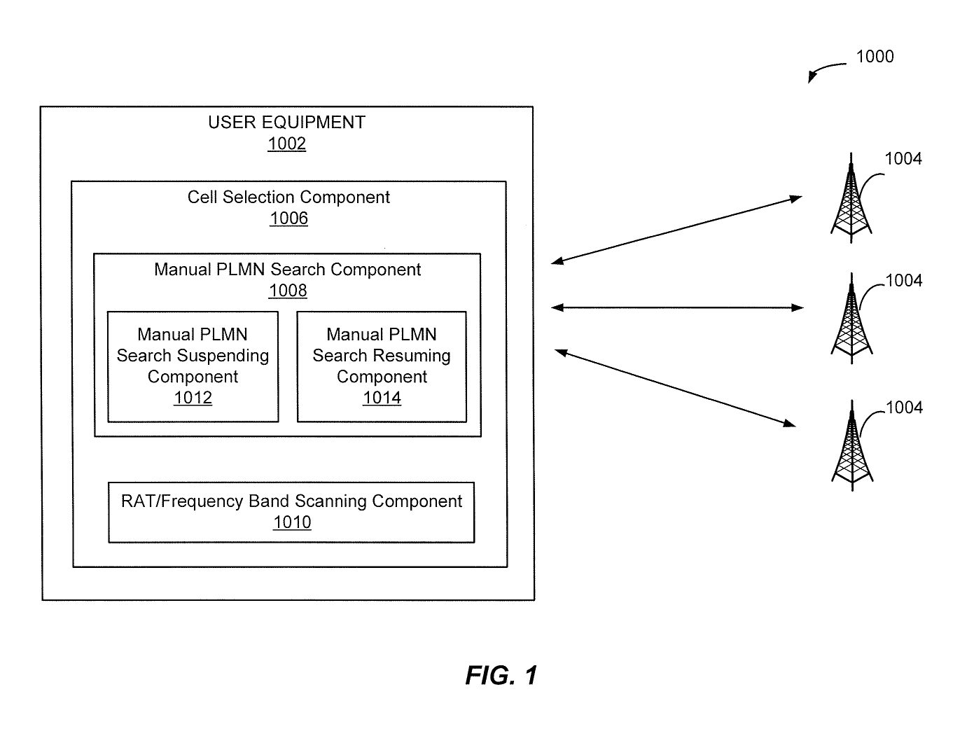

Referring to FIG. 1, in one aspect, a wireless communication system 1000 includes UE 1002 that is communicating with Node Bs 1004 to perform a cell selection. In some aspects, UE 1002 may include cell selection component 1006 that performs cell selection to recover service while a manual PLMN search is ongoing at UE 1002. For example, in some aspects, cell selection component 1006 may include manual PLMN search component 1008 that is configured to execute a manual PLMN search for UE 1002. In some aspects, after a manual PLMN search has started by manual PLMN search component 1008 due to, for example, an OOS or a limited service condition of UE 1002, and while the manual PLMN search is ongoing, cell selection component 1006 of UE 1002 may consider any suitable cell for camping. Hence, UE 1002 may come back in service quickly if there is a suitable cell available during the manual PLMN search, and may then perform activities such as calls or SMSs. Accordingly, the present aspects may improve user experience, as a user may prefer to avoid staying OOS or missing mobile terminated calls or SMSs.

In some present aspects, after a manual PLMN search has started by manual PLMN search component 1008, cell selection component 1006 of UE 1002 may consider any suitable cell for camping that belongs to an RPLMN, a HPLMN, or a preferred PLMN. For example, cell selection component 1006 of UE 1002 may include RAT/frequency band scanning component 1010 that, while a manual PLMN search is ongoing at UE 1002, scans one or more frequency bands that are supported by UE 1002 in order to determine an available cell. In some aspects, when a cell is determined to be available (e.g., there is a good signal/energy available on the cell), cell selection component 1006 may determine if the available cell is suitable (e.g., the UE is not barred from the available cell, or the available cell is reserved for the UE). Upon determining a suitable cell and before continuing the manual PLMN search on the remaining bands or RATS, cell selection component 1006 may suspend the manual PLMN search. For example, in some aspects, manual PLMN search component 1008 of cell selection component 1006 may include manual PLMN search suspending component 1012 that suspends the manual PLMN search when a suitable cell is available. Further, cell selection component 1006 may perform registration at the suitable cell if there is any LAI, RAI, or TAI change.

For example, in an aspect, when a manual PLMN search is ongoing at UE 1002, if an RRC entity (e.g., an LTE RRC entity, a WCDMA-RRC entity, or a GSM-RRC entity determines that there is a good signal/energy available on an RPLMN, a HPLMN, or a preferred PLMN, then cell selection component 1006 of UE 1002 decodes a corresponding SIB or SI related to cell suitability. If a cell is found to be suitable, manual PLMN search suspending component 1012 suspends the manual PLMN search and decodes other mandatory SIBs/SIs. If there is a LAI, RAI, or TAI change, cell selection component 1006 of UE 1002 performs registration and starts decoding pages (e.g., decodes mobile terminated calls) or performs any user activities such as mobile originated calls or SMS.

Conventionally, during a manual PLMN search, WCDMA-RRC reads the MIB of each cell. In some present aspects, however, if a cell belongs to an RPLMN, a HPLMN, or a preferred PLMN, WCDMA-RRC reads an extra SIB (which may be SIB3) to determine whether or not the cell is barred/reserved (e.g., determine cell suitability criterion). Once the process for camping/registration is completed, manual PLMN search resuming component 1014 of manual PLMN search component 1008 may resume the manual PLMN search, and search results may be displayed on a user interface.

Accordingly, in some present aspects, UE 1002 may come back in service quickly (e.g., from acquisition database scan) if there is a suitable cell available during a manual PLMN search and the user may perform activities such as calls, SMSs, etc. As such, the present aspects improve user experience as a user prefers to avoid staying OOS or missing mobile terminated calls and/or SMSs.

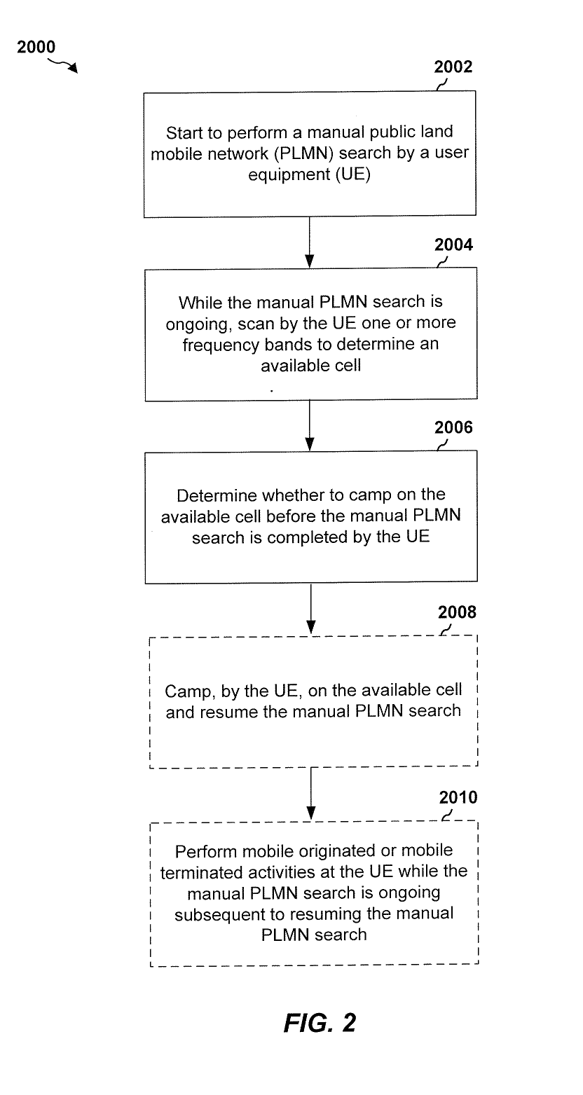

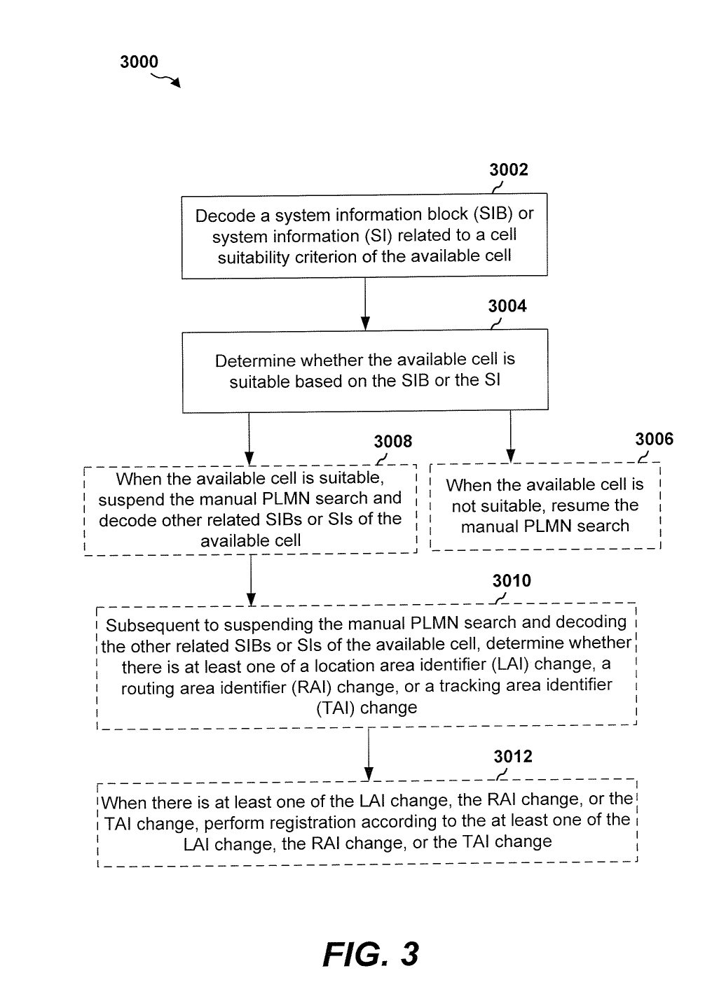

Referring to FIGS. 2 and 3, example methods 2000 and 3000 for wireless communication are illustrated. For explanatory purposes, methods 2000 and 3000 will be discussed with reference to the above described FIG. 1. It should be understood that in other implementations, other systems and/or UEs, Node Bs, or other apparatus comprising different components than those illustrated in FIG. 1 may be used in implementing methods 2000 and 3000 of FIGS. 2 and 3.

At block 2002, method 2000 includes starting to perform a manual PLMN search by a UE. For example, in an aspect, manual PLMN search component 1008 of cell selection component 1006 of UE 1002 may start a manual PLMN search that is performed by UE 1002, e.g., initiate the execution of a manual PLMN search by UE 1002.

At block 2004, method 2000 includes, while the manual PLMN search is ongoing, scanning by the UE one or more frequency bands to determine an available cell. For example, in an aspect, RAT/frequency band scanning component 1010 of cell selection component 1006 of UE 1002 may scan one or more frequency bands to determine an available cell, while the manual PLMN search is ongoing. In some aspects, optionally, RAT/frequency band scanning component 1010 scans the one or more frequency bands if UE 1002 goes OOS while the manual PLMN search is ongoing, in order to determine an available cell.

At block 2006, method 2000 includes determining whether to camp on the available cell before the manual PLMN search is completed by the UE. For example, in an aspect, cell selection component 1006 of UE 1002 may determine whether to camp on the available cell before the manual PLMN search is completed by UE 1002.

Optionally, at block 2008, method 2000 may include camping, by the UE, on the available cell and resuming the manual PLMN search. For example, cell selection component 1006 of UE 1002 may camp on the available cell. Further, manual PLMN search resuming component 1014 of manual PLMN search component 1008 may resume the manual PLMN search.

Optionally, at block 2010, method 2000 may include performing mobile originated or mobile terminated activities at the UE while the manual PLMN search is ongoing subsequent to resuming the manual PLMN search. For example, UE 1002 may perform mobile originated or mobile terminated activities while the manual PLMN search is ongoing subsequent to resuming the manual PLMN search.

Referring now to FIG. 3, method 3000 provides further aspects related to block 2006 of method 2000 to determine whether to camp on the available cell before the manual PLMN search is completed at the UE.

At block 3002, method 3000 includes decoding a SIB or SI related to a cell suitability criterion of the available cell. For example, cell selection component 1006 of UE 1002 may decode a SIB or SI related to a cell suitability criterion of the available cell.

At block 3004, method 3000 includes determining whether the available cell is suitable based on the SIB or the SI. For example, cell selection component 1006 of UE 1002 may determine whether the available cell is suitable based on the SIB or the SI, e.g., whether the available cell is reserved for UE 1002 or whether UE 1002 is barred from the available cell.

Optionally, at block 3006, method 300 may include, when the available cell is not suitable, resuming the manual PLMN search. For example, when the available cell is not suitable, manual PLMN search resuming component 1014 of manual PLMN search component 1008 may resume the manual PLMN search.

Optionally, at block 3008, method 3000 may include, when the available cell is suitable, suspending the manual PLMN search and decoding other related SIBs or SIs of the available cell. For example, when the available cell is suitable, manual PLMN search suspending component 1012 of manual PLMN search component 1008 may suspend the manual PLMN search, and cell selection component 1006 of UE 1002 may decode other related SIBs or SIs of the available cell.

Optionally, at block 3010, method 3000 may include, subsequent to suspending the manual PLMN search and decoding the other related SIBs or SIs of the available cell, determining whether there is at least one of an LAI change, an RAI change, or a TAI change. For example, subsequent to suspending the manual PLMN search and decoding the other related SIBs or SIs of the available cell, cell selection component 1006 of UE 1002 may determine whether there is at least one of an LAI change, an RAI change, or a TAI change.

Optionally, at block 3012, method 3000 may include, when there is at least one of the LAI change, the RAI change, or the TAI change, performing registration according to the at least one of the LAI change, the RAI change, or the TAI change. For example, when there is at least one of the LAI change, the RAI change, or the TAI change, cell selection component 106 of UE 1002 may perform registration according to the at least one of the LAI change, the RAI change, or the TAI change.

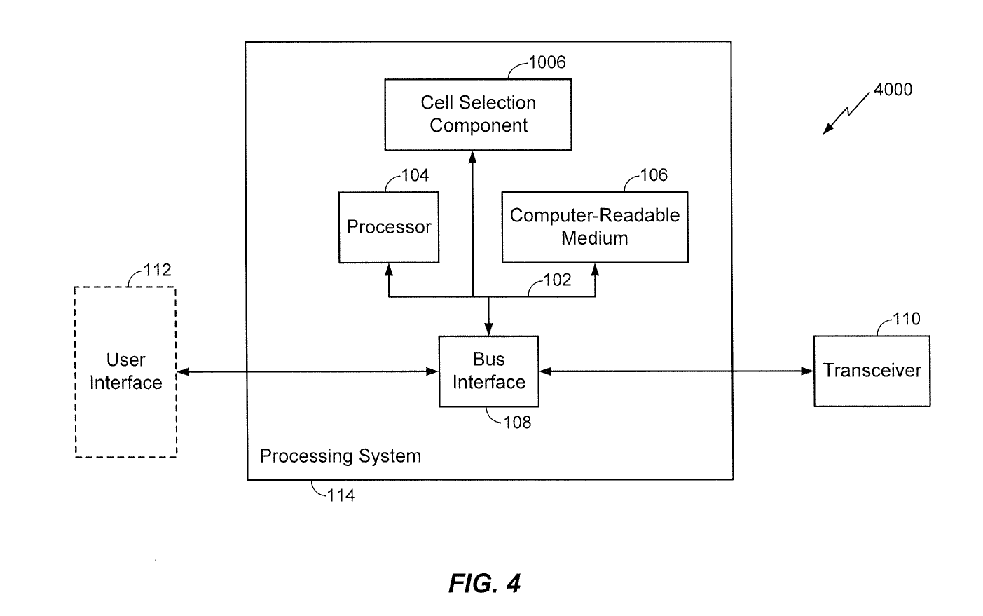

FIG. 4 is a conceptual diagram illustrating an example of a hardware implementation for an apparatus 4000 employing a processing system 114 to operate UE 1002 or cell selection component 1006 (see FIG. 1) to execute any functions described herein with reference to UE 1002 or cell selection component 1006. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including cell selection component 1006, one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. Further, in one aspect, for example, cell selection component 1006 may be implemented by processor 104 executing software and operating in conjunction with computer-readable medium 106 and bus interface 108.

In one aspect, computer-readable medium 106 may include code for starting to perform a manual PLMN search by the apparatus 4000; while the manual PLMN search is ongoing, scanning by the apparatus 4000 one or more frequency bands to determine an available cell; and determining whether to camp on the available cell before the manual PLMN search is completed by the apparatus 4000.

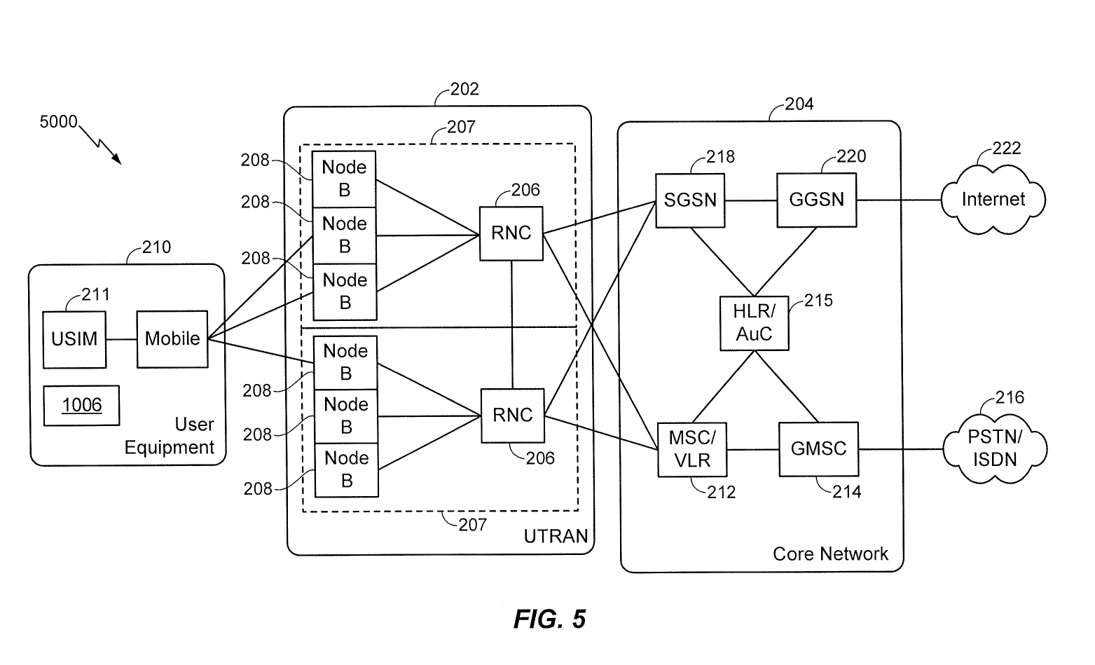

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 5000 employing a W-CDMA air interface. A UMTS network includes three interacting domains: a Core Network (CN) 204, a UMTS Terrestrial Radio Access Network (UTRAN) 202, and User Equipment (UE) 210 (which may be an example of UE 1002 of FIG. 1 and which may include cell selection component 1006 of FIG. 1). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

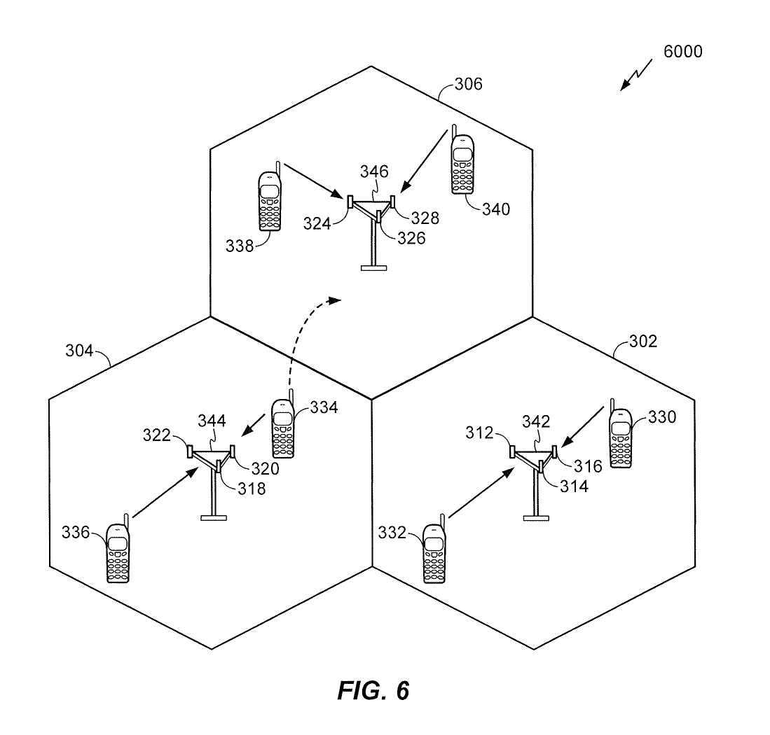

Referring to FIG. 6, an access network 6000 in a UTRAN architecture is illustrated, including UEs 330, 332, 334, 336, 338, 340 which may be examples of UE 1002 of FIG. 1. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 5) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 5), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

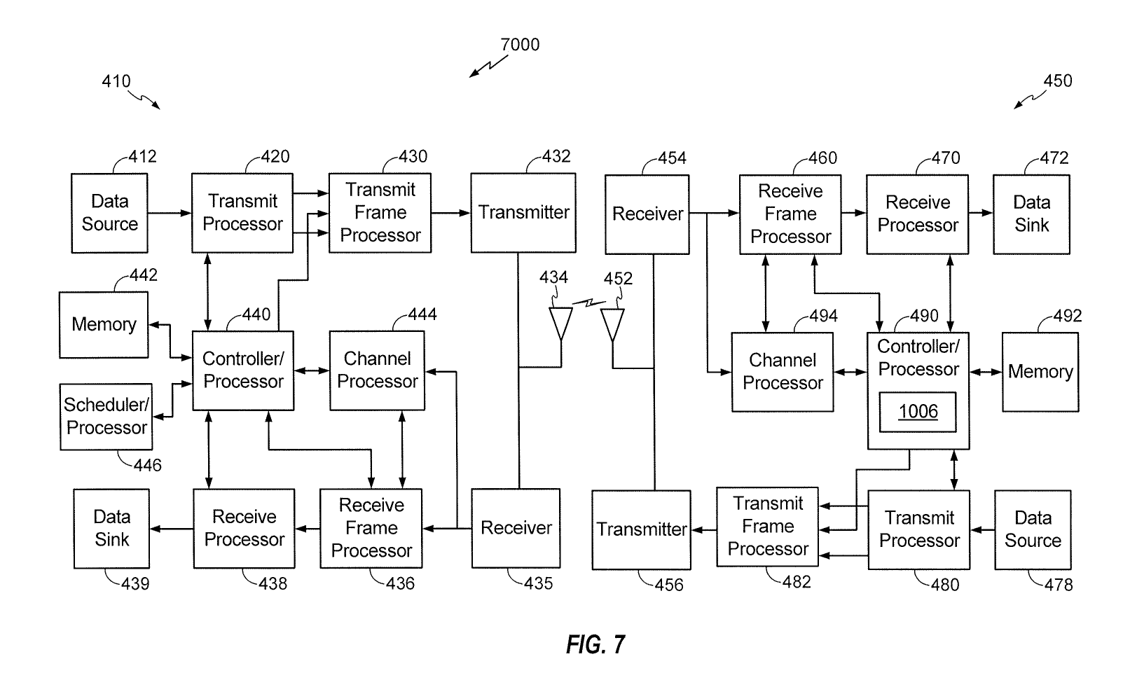

FIG. 7 is a block diagram 7000 of a Node B 410 in communication with a UE 450, where the Node B 410 may an example of Node Bs 1004 in FIG. 1, and the UE 450 may be an example of UE 1002 in FIG. 1 and may include cell selection component 1006 in FIG. 1. In the downlink communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. For example, in accordance with various aspects of the disclosure, an element, or any portion of an element, or any combination of elements may be implemented with processor 104 executing software and operating in conjunction with computer-readable medium 106 and bus interface 108. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
starting to perform a manual public land mobile network (PLMN) search by a user equipment (UE);
while the manual PLMN search is ongoing, scanning by the UE one or more frequency bands to determine an available cell; and
determining whether to camp on the available cell before the manual PLMN search is completed by the UE.

2. The method of claim 1, wherein the starting to perform the manual PLMN search comprises starting to perform the manual PLMN search during an out-of-service period or a limited service period of the UE.

3. The method of claim 1, wherein the determining whether to camp on the available cell comprises:
decoding a system information block (SIB) or system information (SI) related to a cell suitability criterion of the available cell;
determining whether the available cell is suitable based on the SIB or the SI;
when the available cell is suitable, suspending the manual PLMN search and decoding other related SIBs or SIs of the available cell; and
when the available cell is not suitable, resuming the manual PLMN search.

4. The method of claim 3, further comprising:
subsequent to suspending the manual PLMN search and decoding the other related SIBs or SIs of the available cell, determining whether there is at least one of a location area identifier (LAI) change, a routing area identifier (RAI) change, or a tracking area identifier (TAI) change; and
when there is at least one of the LAI change, the RAI change, or the TAI change, performing registration according to at least one of the LAI change, the RAI change, or the TAI change.

5. The method of claim 4, further comprising:
camping, by the UE, on the available cell; and
resuming the manual PLMN search.

6. The method of claim 5, further comprising:
performing mobile originated or mobile terminated activities at the UE while the manual PLMN search is ongoing subsequent to resuming the manual PLMN search.

7. The method of claim 1, wherein the available cell is a registered PLMN (RPLMN) cell, a home PLMN (HPLMN) cell, or a preferred PLMN cell.

8. The method of claim 1, wherein the scanning of the one or more frequency bands comprises scanning the one or more frequency bands when the UE goes out-of-service.

9. An apparatus for wireless communication, comprising:
a processing system configured to:
start to perform a manual public land mobile network (PLMN) search by a user equipment (UE);
while the manual PLMN search is ongoing, scan by the UE one or more frequency bands to determine an available cell; and
determine whether to camp on the available cell before the manual PLMN search is completed by the UE.

10. The apparatus of claim 9, wherein the processing system is configured to start to perform the manual PLMN search during an out-of-service period or a limited service period of the UE.

11. The apparatus of claim 9, wherein the processing system configured to determine whether to camp on the available cell is further configured to:
decode a system information block (SIB) or system information (SI) related to a cell suitability criterion of the available cell;
determine whether the available cell is suitable based on the SIB or the SI;
when the available cell is suitable, suspend the manual PLMN search and decode other related SIBs or SIs of the available cell; and
when the available cell is not suitable, resume the manual PLMN search.

12. The apparatus of claim 11, wherein the processing system is further configured to:
subsequent to suspending the manual PLMN search and decoding the other related SIBs or SIs of the available cell, determine whether there is at least one of a location area identifier (LAI) change, a routing area identifier (RAI) change, or a tracking area identifier (TAI) change; and
when there is at least one of the LAI change, the RAI change, or the TAI change, perform registration according to at least one of the LAI change, the RAI change, or the TAI change.

13. The apparatus of claim 12, wherein the processing system is further configured to:
camp, by the UE, on the available cell; and
resume the manual PLMN search.

14. The apparatus of claim 13, wherein the processing system is further configured to:
perform mobile originated or mobile terminated activities at the UE while the manual PLMN search is ongoing subsequent to resuming the manual PLMN search.

15. The apparatus of claim 9, wherein the available cell is a registered PLMN (RPLMN) cell, a home PLMN (HPLMN) cell, or a preferred PLMN cell.

16. The apparatus of claim 9, wherein the processing system is configured to scan the one or more frequency bands when the UE goes out-of-service.

17. An apparatus for wireless communications, comprising;
means for starting to perform a manual public land mobile network (PLMN) search by a user equipment (UE);
means for, while the manual PLMN search is ongoing, scanning by the UE one or more frequency bands to determine an available cell; and
means for determining whether to camp on the available cell before the manual PLMN search is completed by the UE.

18. The apparatus of claim 17, wherein the means for starting to perform the manual PLMN search starts to perform the manual PLMN search during an out of service period or a limited service period of the UE.

19. The apparatus of claim 17, wherein the means for determining whether to camp on the available cell comprises:
means for decoding a system information block (SIB) or system information (SI) related to a cell suitability criterion of the available cell;
means for determining whether the available cell is suitable based on the SIB or the SI;
means for, when the available cell is suitable, suspending the manual PLMN search and decoding other related SIBs or SIs of the available cell; and
means for, when the available cell is not suitable, resuming the manual PLMN search.

20. The apparatus of claim 19, further comprising:
means for, subsequent to suspending the manual PLMN search and decoding the other related SIBs or SIs of the available cell, determining whether there is at least one of a location area identifier (LAI) change, a routing area identifier (RAI) change, or a tracking area identifier (TAI) change; and
means for, when there is at least one of the LAI change, the RAI change, or the TAI change, performing registration according to at least one of the LAI change, the RAI change, or the TAI change.

21. The apparatus of claim 20, further comprising:
means for camping, by the UE, on the available cell; and
means for resuming the manual PLMN search.

22. The apparatus of claim 21, further comprising:
means for performing mobile originated or mobile terminated activities at the UE while the manual PLMN search is ongoing subsequent to resuming the manual PLMN search.

23. The apparatus of claim 17, wherein the available cell is a registered PLMN (RPLMN) cell, a home PLMN (HPLMN) cell, or a preferred PLMN cell.

24. The apparatus of claim 17, wherein the means for, while the manual PLMN search is ongoing, scanning the one or more frequency bands scans the one or more frequency bands when the UE goes out-of-service.

25. A computer program product for wireless communications, comprising a non-transitory computer-readable medium comprising code for:
starting to perform a manual public land mobile network (PLMN) search by a user equipment (UE);
while the manual PLMN search is ongoing, scanning by the UE one or more frequency bands to determine an available cell; and
determining whether to camp on the available cell before the manual PLMN search is completed by the UE.

26. The computer program product of claim 25, wherein the code for starting to perform the manual PLMN search comprises code for starting to perform the manual PLMN search during an out-of-service period or a limited service period of the UE.

27. The computer program product of claim 26, wherein the code for determining whether to camp on the available cell comprises code for:
decoding a system information block (SIB) or system information (SI) related to a cell suitability criterion of the available cell;
determining whether the available cell is suitable based on the SIB or the SI;
when the available cell is suitable, suspending the manual PLMN search and decoding other related SIBs or SIs of the available cell; and
when the available cell is not suitable, resuming the manual PLMN search.

28. The computer program product of claim 27, wherein the non-transitory computer-readable medium further comprises code for:
subsequent to suspending the manual PLMN search and decoding the other related SIBs or SIs of the available cell, determining whether there is at least one of a location area identifier (LAI) change, a routing area identifier (RAI) change, or a tracking area identifier (TAI) change; and
when there is at least one of the LAI change, the RAI change, or the TAI change, performing registration according to at least one of the LAI change, the RAI change, or the TAI change.

29. The computer program product of claim 28, wherein the non-transitory computer-readable medium further comprises code for:
camping, by the UE, on the available cell; and
resuming the manual PLMN search.

30. The computer program product of claim 29, wherein the non-transitory computer-readable medium further comprises code for:
performing mobile originated or mobile terminated activities at the UE while the manual PLMN search is ongoing subsequent to resuming the manual PLMN search.
